(19) United States
(12) Patent Application Publication
(10) Pub. No.: US 2017/0165607 A1
(43) Pub. Date: Jun. 15, 2017

(54) METHODS AND APPARATUS TO TREAT EXHAUST STREAMS

(71) Applicant: Dürr Systems AG, Bietigheim-Bissingen (DE)

(72) Inventors: Erhard Rieder, Harrenberg (DE); Martin Schröter, Ann Arbor, MI (US)

(21) Appl. No.: 15/445,445

(22) Filed: Feb. 28, 2017

Related U.S. Application Data
(63) Continuation-in-part of application No. PCT/EP2015/068648, filed on Aug. 13, 2015.

(30) Foreign Application Priority Data
Aug. 29, 2014 (DE) 102014112425.1

(51) Int. Cl. B01D 53/34; B01D 46/24; B01D 53/86

(52) U.S. Cl. CPC B01D 53/343; C01B 31/20; B01D 53/8603; B01D 53/8631; B01D 53/8653; B01D 53/8659; B01D 46/2407; B01D 2257/502; B01D 2257/302; B01D 2257/404; B01D 2257/2045; B01D 2257/2047; B01D 2258/0283; B01D 2251/2062; B01D 2251/404

(57) ABSTRACT

Methods and apparatus to treat exhaust streams are disclosed. A disclosed example treatment device to treat a carbon monoxide-containing exhaust stream includes a conversion device to convert carbon monoxide to carbon dioxide, where the energy released in the conversion is used to supply thermal energy and/or electrical energy. The example treatment device also includes a cleaning device to clean the exhaust gas stream to be provided to the conversion device, where the cleaning device is provided upstream in an inlet of the conversion device.

### RELATED APPLICATION

This patent arises as a continuation-in-part of International Patent Application No. PCT/EP2015/068648, which was filed on Aug. 13, 2015, and which claims priority to German Patent Application No. 10 2014 112 425.1, which was filed on Aug. 29, 2014. The foregoing International Patent Application and German Patent Application are hereby incorporated herein by reference in their entireties.

### FIELD OF THE DISCLOSURE

This disclosure relates generally to treatment devices and, more particularly, to methods and apparatus to treat exhaust streams.

### BACKGROUND

An example of an exhaust gas stream containing carbon monoxide can be seen in an exhaust gas stream of an FCC (fluid catalytic cracking) unit, which is produced during regeneration of a catalyst in an FCC unit via partial oxidation of carbon deposits, for example. Depending on the configuration of this unit, forced regenerator operation with insufficient oxygen can cause the carbon to be only partially oxidized to carbon dioxide. In particular, an amount of 4 to 10% by volume can exit the regenerator as carbon monoxide. This carbon monoxide amount provides a usable calorific value of approximately up to 1.5 megajoules per cubic meter under standard conditions (MJ/m³ st.). Further, this calorific value can be used, for example, in a Carbon Monoxide boiler (“CO boiler”) to produce water vapor.

During regeneration of the catalyst at approximately 715 degrees Celsius (° C.), nitrogen oxide on the order of 50-400 ppm/vol. can be produced from the bound nitrogen that is present in coke (e.g., carbon deposits). Parallel to this, bound sulfur that is present in the coke, which can account for up to 30% of the sulfur present in the inlet, is converted in a regenerator to S0₂ and S0₃ (<10%) and emitted on the order of 200 to 3,000 ppm/vol.

A further source of emission is the discharge of the cracking catalyst from the regenerator on the order of up to 10 g/bbl feedstock, which contributes substantially to increasing the concentration of fine particulates by approximately 30-80% of the dust component, but also can result in the formation of a coating, thereby reducing performance of the CO boiler. In particular, to comply with environmental requirements limiting emissions, separate process units for denitrification, desulfurization, and fine particulate reduction are typically used in the outlet of the CO boiler.

For example, known devices and methods for fluid catalytic cracking typically require a series combination of three or more processes that are provided under respectively optimum conditions, in particular, at a reduced temperature of an outlet of a CO boiler. The cleaning processes are, therefore, typically carried out in the exhaust gas stream exiting the CO boiler.

### BRIEF DESCRIPTION OF THE DRAWINGS

FIG. 1 shows a view of a known fluid catalytic cracking unit (FCC unit).

FIG. 2 shows a view of an example advantageous improvement of an FCC unit according to FIG. 1.

FIG. 3 shows a vertical longitudinal cross-sectional view through an example separating device of a cleaning device.

FIG. 4 shows an enlarged view of a separating element of the separating device of FIG. 3.

FIG. 5 shows an enlarged view of the area A of a first example of a separating element, in which a gas-permeable raised surface structure is provided with at least a partial catalytic coating.

FIG. 6 shows a cross-sectional view through the separating element of FIG. 5 along an area VI shown in FIG. 5.

FIG. 7 shows a view of a second example of a separating element according to FIG. 5, which comprises a hollow cylindrical carrier (base element) having at least a partial catalytic coating.

FIG. 8 shows a cross-sectional view through the separating element of FIG. 7 along an area VIII shown in FIG. 7.

FIG. 9 shows a view of a third example separating element according to FIG. 5, which includes a base element implemented as a grid with catalytic inserts filling the grid structure.

FIG. 10 shows a cross-sectional view through the separating element of FIG. 9 along an area X shown in FIG. 9.

FIG. 11 shows a cross-sectional view of a fourth example of a separating element according to FIG. 5, which comprises a gas-permeable wall structure with at least a partial catalytic coating on an inner side and/or an outer side of the wall structure; and

FIG. 12 shows a cross-sectional section through the separating element of FIG. 11 along an area XII shown in FIG. 11.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts. As used in this patent, stating that any part is in any way positioned on (e.g., positioned on, located on, disposed on, or formed on, etc.) another part, means that the referenced part is either in contact with the other part, or that the referenced part is above the other part with one or more intermediate part(s) located therebetween. The same or functionally equivalent elements are shown in all of the figures with the same reference numbers. Stating that any part is in contact with another part means that there is no intermediate part between the two parts.

### DETAILED DESCRIPTION

Methods and apparatus to treat exhaust streams are disclosed. The examples disclosed herein relate to treatment devices to treating an exhaust gas stream such as a carbon monoxide-containing exhaust stream, for example.

An object of the examples disclosed herein is to provide a treatment device that enable energy-efficient utilization for treatment of a carbon monoxide-containing exhaust stream. This object can be achieved according to the examples disclosed herein by a treatment device to treat a carbon monoxide-containing exhaust stream that includes a conversion device for converting carbon monoxide to carbon dioxide, where the energy released in the conversion is used to supply a thermal energy source and/or electrical energy, and a cleaning device to purify the exhaust stream to be provided to the conversion device.

In this example, the term “cleaning” refers to desulfurization, de-nitrification, de-acidification, detoxification, and/or de-dusting. In some examples, a combination of at least two of the above-mentioned methods for environmental treatment of exhausts or exhaust gases or exhaust air is preferable. As used herein, desulfurization of an exhaust gas or an exhaust air refers, in particular, to a reduction in the SOₓ concentration of exhaust gas and/or exhaust air achieved by a suitable technical method. As used herein, denitrification of an exhaust gas or exhaust air is, in particular, to refer to a reduction in the NOₓ concentration of the exhaust gas and/or exhaust air achieved by a suitable technical method. Moreover, as used herein, de-acidification of an exhaust gas or exhaust air refers, in particular, to a reduction in the concentration of acidic components (e.g., HF, HCL, etc.) in the exhaust gas and/or exhaust air achieved by a suitable technical method. In regards to detoxification, toxic components (such as dioxins, furans, etc.) are, preferably, removed and/or substantially reduced by a suitable technical method from an exhaust gas or exhaust air, or their corresponding concentration is reduced. In de-dusting, primarily solid components such as particles, agglomerates, coagulates, and/or ashes are significantly reduced, removed, separated, sieved, and/or filtered from an exhaust gas or exhaust air via a separating device.

As used herein, a thermal energy source is understood in particular to mean a medium by means of which thermal energy can be stored and/or transferred. For example, a thermal energy source can refer to a warmed, heated, and/or vaporized fluid such as water and/or a hot gas (e.g., hot exhaust gas).

Because the treatment device according to the examples disclosed herein include a cleaning device by which the exhaust gas stream to be provided to the conversion device can be cleaned, the presence of the cleaning device enables cleaning the exhaust gas stream with relatively high (e.g., optimized) energy efficiency. For example, this cleaning can be specifically provided upstream at an inlet of the conversion device such as, for example, a CO boiler and/or a gas turbine unit (e.g., a micro gas turbine unit). This arrangement of the cleaning device allows advantageous reduction or even prevention of contamination of the downstream conversion device by potentially harmful substances that can be present in the original exhaust gas stream.

In a known example, DE 102013203448.2, which is hereby incorporated by reference, shows a gas turbine unit, in particular, a micro gas turbine unit that is used for the treatment and/or energy recovery of combustible components present in exhaust gas or exhaust air that has a burner with a heatable combustion chamber. This unit includes a reaction chamber through which a gaseous medium can flow. The reaction chamber has an inlet opening through which the exhaust gas or exhaust air flows into the reaction chamber. The reaction chamber also has an outlet opening through which the exhaust gas or the exhaust air from the reaction chamber flows into a hot gas channel for discharging the treated exhaust gas from the reaction chamber. In this unit, the exhaust gas or exhaust air containing the combustible components is burned along with strong gas. Combustible gas or a gas mixture with a calorific value, HA, that is greater than 15 MJ/Nm3 is referred to herein as strong gas. In contrast, the calorific value of weak gas such as gas formed by the exhaust gas or exhaust is sharply reduced. The strong gas burned in the unit may be a gas such as natural gas (e.g., bio-natural gas).

With respect to the detailed configuration of the illustrative gas turbine unit, in particular, a micro gas turbine unit, reference is made to DE 102013203448.2, the disclosure of which is explicitly incorporated herein, without said reference being understood as limitative. In addition to this specific gas turbine unit, in particular, a micro gas turbine unit, alternative examples of gas turbine units, in particular, micro gas turbine units, are also known to the person skilled in the art. In particular, suitable examples of a conversion device not having the reaction chamber are disclosed in DE 102013203448.2, which is also hereby incorporated by reference, in particular, for converting weak gas.

In some examples, it can be advantageous if the cleaning device includes a feeding device to provide (e.g., feed) at least one additive to the exhaust gas stream. As used herein, an additive is understood to refer, in particular, to a mixture, a dispersion, an emulsion, and/or a solution of additives, where the components of the mixtures, dispersions, emulsions, and/or solutions can be solid, liquid, and/or gaseous. Such an additive can be, preferably, characterized such that the additive promotes or supports at least one of separating, cleaning, and/or conversion process provided in the cleaning device and/or acting on the exhaust gas stream and/or is necessary for the aforementioned processes.

For example, the feeding device can include a nozzle grid by means of which additives can be fed to the exhaust stream over wide areas and/or at individual points. The example feeding device can, preferably, further including and/or constitute a mixing device.

By use of the example mixing device, one or a plurality of additives and/or the exhaust gas of the exhaust gas stream can be, preferably, miscible with one another. For example, the mixing device includes a mixing chamber and/or a mixing unit (e.g., an agitator), in which one or a plurality of additives and/or the exhaust gas of the exhaust gas stream are miscible with one another. In some examples, one or a plurality of swirling devices and/or mixing elements can be provided in the mixing chamber for this purpose.

One or a plurality of mixing elements are for example configured as a mixing wheel or a cellular wheel. Alternatively or additionally, mixing elements that implemented as baffle plates, swirl generators, and/or turbulence generators can be implemented.

In some examples, it can be advantageous if, by use of the feeding device, an ammonia-containing and/or lime-containing additive is provided to the exhaust gas stream. In particular, the feeding device provides an ammonia-air mixture or aqueous ammonia to the exhaust gas stream.

In some examples, it can be advantageous for a nitrogen oxide measurement to be performed by a measuring device of the treatment device at an outlet of the cleaning device. Preferably, in some examples, a feeding device can be used to selectively control and/or regulate the amount of the additive supplied based on a measured amount and/or concentration of nitrogen oxide. In some examples, a lime-containing additive is an aqueous lime solution. In some examples, it is advantageous if sulfur oxide measurement is performed at an outlet of the cleaning device by a measuring device of the cleaning device. In some preferable examples, the amount of the additive supplied can be controlled and/or regulated based on the measured amount and/or concentration of sulfur oxide.

In some examples, the treatment device is, preferably, provided with a control device for control and/or regulation of the amount of the additive fed in. The control device is preferably implemented such that the amount of the additive supplied is controllable and/or regulated based on a measured amount of nitrogen oxide and/or a measured amount of sulfur oxide.

In some examples, the cleaning device includes a separating device such as, in particular, a filter device. By implementing the separating device, a solid component can, preferably, be reduced and/or removed from the exhaust gas stream, for example. For example, the separating device may be a catalyst separating device such as, in particular a catalyst separating device for converting nitrogen oxides. As used herein, a catalyst separating device is understood to refer to a filter device in the throughput direction or path of which at least partially catalytically active material is positioned, incorporated, and/or provided. The throughput direction or throughput path is understood herein to refer to the passage of the fluid, exhaust gas, or exhaust air stream to be cleaned through the separating or filter device. As used herein, a catalytically active material refers to a substance or a substance mixture that facilitates or allows a chemical conversion reaction of at least one component of the fluid, exhaust gas, or exhaust air stream to another composition.

For example, the separating device can be a catalyst separating device, in particular a catalyst separating device to convert nitrogen oxides and hydrocarbons (e.g., volatile hydrocarbons (volatile organic compounds; VOC), dioxins, furans, etc.). The separating device may preferably include one or a plurality of separating elements. In some examples, one or a plurality of separating elements are preferably configured as filter elements. A filter element may be, in particular, a surface filter or a depth filter. In a surface filter, for example, separation is, preferably, occurs by accumulation of particles to be separated on a filter cake that forms on the filter. In a depth filter, for example, the actual separating effect may, preferably, occur by deposition of the particles to be separated in the filter element.

In some alternate examples to one or a plurality of separating elements configured as filter elements, one or a plurality of separating elements are, preferably, implemented as an electrostatic separator, a cyclone separator, a wet separator, and/or a water separator. In some examples, one or a plurality of separating elements of the separating device are, preferably, implemented as a filter candle.

A separating element such as, in particular, a filter element, and, preferably, a filter candle in some examples, may be a hollow cylinder-shaped element (e.g., a hollow circular cylinder-shaped element).

Alternatively, in some examples, other elongated hollow bodies may also be used as a separating element. Some example suitable elements include generally hollow cylinders having polygonal cross-sectional surfaces (e.g., triangular, square, pentagonal, hexagonal, or octagonal cross-sectional profiles, higher-order polygons and/or five, six, or multiple-pointed star-shaped cross-sectional profiles) and/or cross-sectional surfaces having parabolic, elliptical, or hyperbolic sections. In such examples, higher-order cross-sectional geometries (e.g., star surfaces) can be advantageous by providing larger sheath surfaces on the separating element, for example.

In some examples, a separating element is, preferably, implemented closed at one end. In particular, one end of a hollow cylinder-shaped element, in particular a hollow circular cylinder-shaped element is closed, while the other end is opened.

In some examples, an exhaust gas stream to be cleaned, preferably, flows through a separating element along a radial direction relative to a longitudinal axis and/or a symmetrical axis extending between the outside and the inside. Preferably, a closed end of a separating element may extends into a raw gas compartment of a separating chamber of the separating device, for example.

In some examples, an open end of a separating element, preferably, faces toward a clean gas compartment of a separating chamber of the separating device. An internal compartment of a separating element such as, in particular, a hollow cylinder-shaped element (e.g., a hollow circular cylinder-shaped element), is preferably open towards a clean gas compartment of the separating chamber, for example.

In some examples, it can be favorable when the separating device includes one or a plurality of separating elements having a base element. In some examples, the base element is, preferably, provided with one or a plurality of coatings. Alternatively or additionally, the base element is provided with one or a plurality of fillings. In some examples, the base element is, preferably, a relatively dimensionally stable component that defines a basic form of a separating element.

In some examples, the base element, preferably, forms a supporting structure or a carrier for additional components of the separating element (e.g., for one or a plurality of coatings and/or one or a plurality of fillings).

Preferably, in some examples, the base element is at least partially gas-permeable. On one hand, for this purpose, openings can be provided in the base element that result from the macroscopic design of the base element. Alternatively or additionally, the base element may be at least partially gas-permeable because of the material (e.g., material-related gas permeability may occur in an open-pore or open-cell material).

As used herein, the term “coating” is to be understood as an inner and/or outer surface of the base element is provided with an additional material (coating material). This coating, preferably, does not limit the gas permeability of the base element, for example. In particular, a gas-permeable structure (e.g., an open-pore or open-cell structure) of the base element may, preferably, be retained, for example.

As used herein, the term “a filling” refers to a partial or complete filling of a cavity of the base element. In particular, the gas permeability of the base element may, preferably, be hindered by such a filling, unless the filling material itself is gas-permeable, for example.

A coating may form a protective layer, for example. An example coating may include polytetrafluoroethylene (PTFE), polypropylene (PP), polyethylene (PE), and/or polyamide (PA) or be composed of one or of a plurality of any of the aforementioned materials (or any other appropriate material).

In the examples disclosed herein, example features of a coating and/or a filling of the base element are described. However, these features may also be achieved if a coating and/or filling is provided with a coating and/or filling. In particular, a catalytically active coating of the base element may be provided with a coating and/or one or a plurality of fillings implemented as a protective layer, for example.

In some examples, it may be favorable for the base element to include a plastic material, a ceramic material, a vitreous material, and/or a metal material, or to be composed of a plastic material, a ceramic material, a vitreous material, and/or a metal material.

As used herein, the term “vitreous material” refers to an amorphous substance (e.g., an amorphous solid). For example, an organic vitreous material can be provided such as, in particular plastic, which has an amorphous structure, for example. Moreover, an inorganic vitreous material such as, in particular silicate glass, quartz glass, etc., may also be provided. A vitreous material is for example a glass fiber-like material, in particular a glass fiber material. A ceramic material may include, for example, cordierite and/or mullite. For example, the base element can be composed of a hardened and/or stiffened metal foam. In some examples, the base element includes an open-pore or open-cell metal foam. In some examples, a metal material such as, in particular, a material of an open-pore or open-cell metal foam, may be a stainless steel (e.g., a FeCrAl alloy).

In some examples, it is favorable when the base element includes an aluminum foam material or is at least partially composed of an aluminum foam material, for example. Further, in some examples, the base element includes a sintered metal and/or is implemented as a sintered metal component. Alternatively or additionally, the base element can include a hollow sphere structure and/or is composed of a material having a hollow sphere structure.

In some examples in accordance with the teachings of this disclosure, the base element includes a metal grid, which may be at least partially composed of iron and/or palladium, for example. In some examples, the grid cells of the metal grid are then provided with a filling (e.g., a gas-permeable catalytically active (effective) filling).

In some examples, the separating element can be implemented such that a metal grid is improved to provide an essentially closed layer by filling of the grid cells. For example, by rolling up the metal grid or the entire closed layer into a hollow cylinder, a separating element implemented as a filter candle can, preferably, be defined (e.g., formed). In this example, only one of the two still-open ends of the separating element is, preferably, closed. The separating element can then be provided with an additional coating (e.g., a protective layer).

In some examples, a coating such as, in particular, a protective layer, can be a perforated and/or otherwise gas-permeable film, a mesh, a physical, a chemical coating, and/or a vapor-deposition coating on the base element or a further coating of a separating element. In some examples, it may be favorable if the base element is provided with one or a plurality of gas-permeable and/or catalytically active coatings. Alternatively or additionally, it can be provided that the base element is provided with one or a plurality of gas-permeable and/or catalytically active fillings.

As used herein, the term “catalytic activity” refers to potentially harmful substances (e.g., potentially harmful gases) of the exhaust gas stream that can be more efficiently chemically converted by contact with the catalytically active coating and/or the catalytically active filling (e.g., by reduction of an activation energy and/or shifting of an equilibrium point of an equilibrium reaction).

In some examples, a catalytically active coating and/or a catalytically active filling can include one or more of the following materials: copper, nickel, nickel oxide, palladium, platinum, rhodium, gold, and/or other catalytically active elements and/or compounds. Moreover, in some examples, a coating of platinum group metals and/or perovskite-like metal mixed oxides (e.g., La0.9Ag0.1MnO3) may be provided.

In some examples, a catalytically active material may be preferably chemically and/or physically incorporated into a material forming the coating, the filling, and/or the base element and/or connected with said material and/or to the material. In some examples, a coating and/or a filling of a separating element is, preferably, chemically and/or physically bonded to the base element. In some examples, the separating device includes one or a plurality of separating elements that have a structured surface. In particular, a structured surface can be a surface having a wavy and/or zigzag-shaped course with respect to a longitudinal section taken parallel to a longitudinal axis or symmetrical axis of a separating element, for example. In some examples, it is advantageous when the separating device comprises a separating chamber, which, preferably, includes the following: a feed section, through which an exhaust gas stream to be cleaned can be fed to an internal compartment of the separating chamber; a discharge section, through which a cleaned exhaust gas stream can be discharged from the internal compartment of the separating chamber; and/or a mounting device for the mounting, arrangement, and/or attachment of one or a plurality of separating elements of the separating device.

In some examples, it is favorable when one or a plurality of separating elements of the separating device are or can be detachably, interchangeably, and/or exchangeably fixed to the mounting device. Further, it may be advantageous when one or a plurality of separating elements are fixed or coupled to the mounting device in a sealing manner, for example.

In some examples, the mounting device includes a generally plate-shaped element that includes duct openings. The separating elements of the separating device are, preferably, arrangeable in the duct openings (e.g., detachably arrangeable). In some examples, a feed section of the separating chamber, preferably, includes an inlet opening and/or an inlet connector. In some examples, a discharge section, preferably, includes an outlet opening and/or an outlet connector.

Preferably, in some examples, a flow path between the feed section, in particular, the inlet connector, and the discharge section, in particular the outlet connector, is provided such that an exhaust gas stream entering the internal compartment of the separating chamber through the feed section flows over the one or a plurality of separating elements or passes through the separating elements to reach the discharge section and be discharged therefrom.

In some examples, it is favorable when the cleaning device includes a backflushing device to clean the separating device. By the backflushing device, it is possible to produce a fluid flow in the reverse direction to substantially reduce and/or remove solids and other residues and/or deposits from the one or a plurality of separating elements of the separating device. The fluid flow in the reverse direction is, in particular, a fluid flow that is opposite to the direction in which the exhaust gas stream flows through the separating device during separating operation of the separating device.

In some examples, the backflushing device may be a compressed air device. Such a compressed air device preferably includes one or a plurality of cleaning lances, by which compressed air pulses can be emitted into the interior of the one or a plurality of separating elements to achieve flow therethrough in a radial direction toward the outside and, thus, cleaning of impurities from an outer surface of the separating element in a radial direction.

In some examples, the cleaning device includes a discharge device by which solids separated from the exhaust gas stream can be discharged. In particular, by implementation of the discharge device, solids and other residues and deposits may be substantially reduced (e.g., removed) from one or a plurality of separating elements of the separating device after a backflushing operation is performed. A discharge device may be a carrying-off device, for example. In particular, a discharge device can include one or a plurality of conveyor belts and/or one or a plurality of cellular wheel sluices. By use of the discharge device, filter cake fragments, dusts, etc. can, preferably, be discharged, for example.

Preferably, in some examples, an exhaust system is provided in such that the gas stream is mixed with the provided and/or fed-in additive or additives, and a suitable residence time is provided, for example, to convert sulfur oxide to calcium sulfite and/or calcium sulfate.

In some examples, a solid portion of the exhaust gas stream is preferably reduced and/or removed on the surface of the separating element prior to the stream entering the separating element.

In some examples, Nitrogen oxide of the exhaust gas stream is, preferably, converted with fed-in ammonia to nitrogen and water during passage through the separating element of the separating device, in particular, by using a catalytic coating or catalytic substance of the separating device, for example.

In particular, in some examples, a filter cake on the separating element of the separating device may be reduced and/or removed through regular backflushing via the backflushing device. Finally, by use of the discharge device, the material forming the filter cake may, preferably, be discharged from the entire cleaning device.

Preferably, in some examples, process steps for denitrification, desulfurization, and de-dusting of the exhaust gas stream are integrated into a combined process step and/or reduced to a single process step.

In some examples, an inlet of an energy recovery device is, preferably, repositioned at the installation site of this one process step, in particular, such as an area in which, for example, relatively optimal (e.g., optimum) temperatures for the catalyst separating device prevail.

In some examples, it can be favorable if the dust exposure of the energy recovery device and the required cleaning work are reduced. In such examples, cleaning intervals can, preferably, be lengthened.

In some examples, a filter cake separated in the filter device can, preferably, be discharged in a dry state, which can make handling, further processing, and storage relatively unproblematic. In addition, investment costs can, preferably, be reduced.

Some of the examples disclosed herein further relate to a method for treating a carbon monoxide-containing exhaust stream.

In this respect, the object of the examples disclosed herein is to provide a method by which relatively energy-efficient treatment of a carbon monoxide-containing exhaust stream can be carried out.

This object is achieved according to the examples disclosed herein by a method for treating a carbon monoxide-containing exhaust stream, wherein the method comprises the following: cleaning of an exhaust gas stream by means of a cleaning device; feeding of the cleaned exhaust gas stream to a conversion device; and conversion of carbon monoxide to carbon dioxide by means of the conversion device, where the energy released in the conversion is used to supply a thermal energy source and/or electrical energy, in particular, to vaporize water.

The method according to the examples disclosed herein preferably shows individual or multiple features and/or advantages described in connection with the treatment device according to the examples disclosed herein.

In some examples, the cleaning of the exhaust gas stream preferably includes the following: feeding of the exhaust gas stream to a cleaning device; cleaning of the exhaust gas stream by means of the cleaning device by separation of particles and/or by catalytic conversion of at least one harmful substance, in particular a harmful gas.

In some examples, it can be advantageous if the exhaust gas stream is cleaned by one or a plurality of separating elements of a separating device of the cleaning device by separation of particles and/or by catalytic conversion of at least one potentially harmful substance (e.g., a potentially harmful gas).

In some examples, to clean the exhaust gas stream, the stream is, preferably, caused to pass through one or a plurality of separating elements configured as filter candles.

In some examples, it can be favorable if the exhaust gas stream, after cleaning thereof by the cleaning device, is provided to an energy recovery device, for example. In particular, this may allow heat to be withdrawn from the exhaust gas stream that would otherwise be released into the environment, for example.

In some examples, it can be favorable if an additive (e.g., an ammonia-containing and/or lime-containing additive) is provided to, added to, and/or mixed with the exhaust gas stream by a feeding device.

In some examples, by use of a separating device of the cleaning device, in particular, by use of a catalyst separating device of the cleaning device, solids are, preferably, separated from the exhaust gas.

In some preferable examples, the stream flows through the separating device for removal of separated solids by a backflushing device of the cleaning device in a direction opposite to the flow direction of the separating device during a separation operation.

In some examples, the solids separated by the separating device are, preferably, discharged from the separating device by a discharge device of the cleaning device.

The examples disclosed herein further relate to the use of a treatment device, in particular, a treatment device according to the examples disclosed herein to treat a carbon monoxide-containing exhaust stream, in accordance with the teachings of this disclosure.

The use according to the examples disclosed herein preferably shows individual or multiple features and/or advantages described in connection with the treatment device according to the examples disclosed herein and/or the method according to the examples disclosed herein. In particular, it can be provided that the cleaning device is arranged upstream of the conversion device. As used herein, the term “upstream” refers to the flow direction of the exhaust gas stream to be treated.

In some examples, it can be favorable if, by the cleaning device, solids as well as nitrogen oxide and sulfur oxide in the exhaust gas stream are reduced or separated, in particular, prior to the exhaust gas stream being provided to the conversion device.

The treatment device according to the examples disclosed herein, the method according to the examples disclosed herein, and/or the use according to the examples disclosed herein, preferably, also show individual or multiple features and/or advantages as described below.

In some examples, the separating device preferably includes one or a plurality of separating elements, which for example include a ceramic material impregnated with a catalytic substance.

In some examples, it can be favorable if the exhaust gas stream provided to the cleaning device process is at least partially composed of exhaust air from an expansion turbine of a regenerator. For example, the process exhaust air can be mixed exhaust air of a first stage of a regenerator (e.g., a first regeneration stage) and a waste heat boiler of a second stage of the regenerator (e.g., a second regeneration stage).

However, in some examples, the exhaust gas stream to be provided to the cleaning device is at least almost exclusively process exhaust air of a first stage of a regenerator or a waste heat boiler of a second stage of the regenerator.

Preferably, in some examples, an exhaust system is implemented in such that the gas stream is mixed with the fed-in additive or additives and a suitable residence time is provided to convert, for example, sulfur oxide to calcium sulfite and/or calcium sulfate.

In some examples, a solid portion of the exhaust gas stream is, preferably, separated on the surface of the separating element before the stream enters said separating element.

In some examples, nitrogen oxide in the exhaust gas stream is, preferably, converted with fed-in ammonia to nitrogen and water during passage through the separating element of the separating device, in particular, by using a catalytic coating or catalytic substance of the separating device.

In particular, a filter cake on the separating element of the separating device may, preferably, be reduced and/or removed via typical backflushing by the backflushing device. Finally, by use of the discharge device, the material forming the filter cake can, preferably, be discharged from the entire cleaning device. Preferably, in some examples, process steps for denitrification, desulfurization, and de-dusting of the exhaust gas stream are integrated into a combined process step and/or reduced to a single process step. For example, an installation site of this one process step is, preferably, repositioned at an inlet of the CO boiler (e.g., an area in which for example optimal temperatures for the catalyst separating device prevail).

In some examples, it can be favorable if the dust exposure of the CO boiler and the required cleaning work are reduced. In such examples, cleaning intervals can preferably be lengthened.

In some examples, it can be favorable if the water vapor consumption of the soot blowers of the CO boiler is reduced (e.g., minimized).

In some examples, during use in the described cleaning device, a CO boiler, preferably, shows low pressure loss and increased efficiency. In particular, this makes it possible to economize on externally fed-in fuel, for example.

In some examples, a filter cake separated by the separating device can, preferably, be discharged in a dry state, which can make handling, further processing, and storage relatively unproblematic. In addition, investment costs may be reduced.

In some examples, a CO boiler is, in particular, a conversion device to convert carbon monoxide to carbon dioxide, where the energy released in the conversion is used to supply a thermal energy source, in particular, to provide a warmed, heated, overheated, and/or vaporized fluid, for example, to vaporize water.

As used herein, a thermal energy source is understood, in particular, to refer to a fluid, which in the CO boiler is at least partially converted from a first, lower-order thermal energy state to a second, higher-order thermal energy state and can be provided to an additional process, where at least a part of an energy difference between the second and the first energy state can be transferred to the following process, in particular, to an energy absorber of the following process.

In some examples, it can be favorable if thermal energy of a conversion device, in particular of a CO boiler, is converted to electrical energy, for example, by an organic Rankine cycle unit (ORC unit).

In some examples, the cleaning device, preferably, includes a separating device to separate particles from the exhaust gas stream and/or catalytic conversion of at least one potentially harmful substance (e.g., a potentially harmful gas from the exhaust gas stream).

As used herein the term “particles” refers to solid, liquid, and/or gaseous impurities in the exhaust gas stream. Solid and/or liquid impurities may be preferably separated, and particularly filtered by the separating device. Gaseous impurities, which in particular form a potentially harmful gas of the exhaust gas stream, are, preferably, catalytically converted by the separating device (e.g., chemically converted, preferably to less harmful substances).

In particular, in some examples, harmful substances are substances or substance mixtures that may be harmful to humans, animals, plants, or other organisms, as well as entire ecosystems. Such damage can occur from absorption of the harmful substances by organisms or entry into an ecosystem or its biomass. A substance is, preferably, defined as harmful or potentially based on its effect on an ecosystem (e.g., ranging from microbes to plants, animals, and humans).

In particular, a harmful substance may be considered to be a harmful substance if its amount and/or concentration is above legal limits.

In some examples, it can be advantageous if the feeding device comprises a nozzle grid or any other appropriate injection device by which one or a plurality of additives may be provided to the exhaust stream over wide areas and/or at individual points.

A feeding device includes, for example, a plurality of nozzles arranged in the general form of a matrix, which may be arranged or distributed as evenly distributed in a plane perpendicular to a flow direction of the exhaust gas stream.

Alternatively or additionally, the feeding device includes one or a plurality of inflow devices, by which one or a plurality of additives can be provided into the exhaust gas stream transversely, in particular, relatively perpendicular to a flow direction of the exhaust gas stream.

In some examples, a separating device that is implemented as a catalytic device is, in particular, a combination of a catalyst and a particle trap.

In some examples, the separating device, preferably, enables operation at temperatures of at least approximately 300° C. (e.g., at least approximately 450° C., and in some examples, approximately 600° C.).

In some examples, a separating device, preferably, shows a high specific volume flow density, which means that a volume flow of the exhaust gas stream is very high relative to the volume of the separator (separating device).

Further preferred features and/or advantages of the examples disclosed herein are the subject matter of the following description and the drawings of the examples disclosed herein.

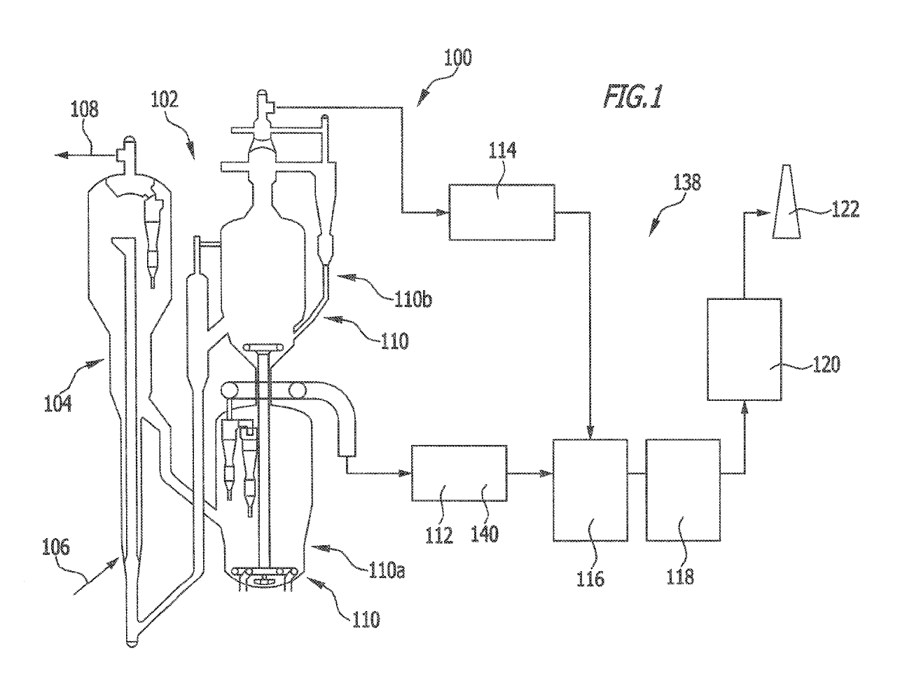

Turning to FIG. 1, an example FCC unit (fluid catalytic cracking unit) designated as a whole by 100 is used to convert materials in the petroleum processing industry. For example, the FCC unit 100 may be used for conversion of heavy petroleum fractions to olefins, cat cracker gasoline, and gas oil and heavy oil components.

The example FCC unit 100 includes a cracking device 102, in which the actual conversion process of the petroleum fed in as crude oil is carried out. The cracking device 102 of the illustrated example includes a cracking section 104 to which crude oil can be fed via a crude oil feed line 106.

After conversion of the crude oil is completed, the products produced in this process may be discharged via a product discharge line 108 of the cracking device 102, for example. During conversion of the provided crude oil, catalyst material is produced, which is regenerated in two regeneration stages 110, for example, in particular, a first regeneration stage 110a and a second regeneration stage 110b of the cracking device 102 after being used in the cracking section 104. In particular, coke that is deposited on the catalyst material during conversion of the crude oil may be removed from the catalyst material.

In this example, the catalyst material is reused in the cracking section 104 after regeneration. During regeneration of the catalyst material, exhaust gas, which can contain a large number of harmful substances, is produced. In particular, this exhaust gas includes nitrogen oxide (NOₓ) and sulfur oxide (SOₓ), as well as solid particles, for example.

The exhaust gas further comprises carbon monoxide, which is produced, in particular, with insufficient oxygen in the regeneration stages 110 due to incomplete oxidation of carbon-containing particles such as, in particular, coke, for example.

In the example configuration of an FCC unit 100 shown in FIG. 1, the carbon monoxide is converted in an example CO boiler 112 to carbon dioxide, and, in particular, is oxidized. The energy released from this conversion is utilized in the CO boiler 112 to vaporize water, for example. By use of the CO boiler 112, the chemical energy present in the exhaust gas from the regeneration stages 110 can, therefore, be used to produce water vapor in some examples.

The example FCC unit 100 further includes a waste heat boiler 114 to utilize waste heat of the exhaust gas that is discharged from the regeneration stages 110, in particular, the second regeneration stage 110b. Therefore, in some examples, it should, preferably, be possible for an exhaust gas stream from the second regeneration stage 110b to flow through the waste heat boiler 114. Exhaust gas from the first regeneration stage 110a in particular can be fed to the CO boiler 112.

The exhaust gas flows passing through the waste heat boiler 114 and the CO boiler 112 may be still highly contaminated and should, therefore, be cleaned before any possible release into the environment. For this purpose, the FCC unit 100 of the illustrated example includes a denitrification device 116, a desulfurization device 118, and a separating device 120.

By use of the example denitrification device 116, nitrogen oxide, in particular, may be reduced and/or removed from the exhaust gas, in particular, by chemical conversion to nitrogen and further products, for example.

By use of the example desulfurization device 118, sulfur oxide, in particular, may be significantly reduced and/or removed from the exhaust gas stream, in particular, by conversion of the sulfur oxide to calcium sulfite or calcium sulfate (gypsum).

By use of the example separating device 120, which is configured in this example as an electrostatic separator, solid particles can, preferably, be removed from the exhaust gas stream.

The exhaust gas stream cleaned by use of the denitrification device 116, the desulfurization device 118, and the separating device 120 may be released into the environment via an exhaust air discharge line 122 of the FCC unit 100.

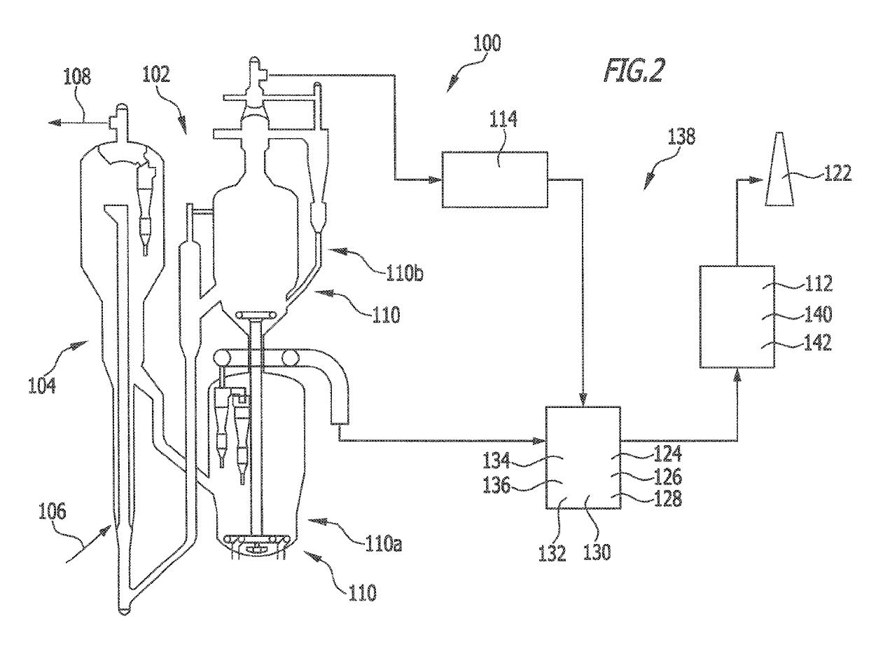

A second example of an FCC unit 100 shown in FIG. 2 differs from the first example shown in FIG. 1 in that the cleaning of the exhaust gas stream takes place before providing thereof to the CO boiler 112. In this example, the FCC unit 100 also includes a cleaning device 124.

In some examples, exhaust gas from the first regeneration stage 110a and/or exhaust gas from the second regeneration stage 110b can be provided to the cleaning device 124.

In some examples, exhaust gas from the second regeneration stage 110b provided through the waste heat boiler 114 and exhaust gas discharged directly from the first regeneration stage 110a can be provided to the cleaning device 124.

In this example, the cleaning device 124 is arranged or positioned upstream of the CO boiler 112 so that cleaned exhaust gas can be provided to the CO boiler 112. In some examples, the cleaning device 124, preferably, includes a feeding device 126 for feeding an additive to the exhaust gas stream.

In this example, the additive is, in particular, an ammonia-containing and/or lime-containing additive, so that in the presence of a catalyst, nitrogen oxide and sulfur oxide can be reduced and/or removed from the exhaust gas stream.

In this example, the cleaning device 124 further includes a separating device 128 by which solids can be separated from the exhaust gas stream. For example, the separating device 128 is a catalyst separating device 130 that provides the catalyst surface required for conversion of the nitrogen oxide. For this purpose, the catalyst separating device 130 of the illustrated example is configured as a separating device 128 provided with a catalytically active coating, for example.

Preferably, in some examples, the cleaning device 124 includes a mixing device 132, by which the exhaust gas stream and the provided additive(s) are miscible with one another.

The cleaning device 124 also includes a backflushing device 134 and a discharge device 136. For example, by use of the backflushing device 134, backflushing operation of the separating device 128 can be carried out. In this example, the stream flows through the separating device 128 in a direction opposite to the usual flow direction during separation in order to reduce and/or remove a filter cake from the separating device 128, in particular, to blow it out. The filter cake removed in this manner is removable, in particular, by use of the discharge device 136, for example.

The example cleaning device 124 and the example CO boiler 112 are components of a treatment device 138 for treating a carbon monoxide-containing exhaust stream. In this example, the CO boiler 112 constitutes a conversion device 140 to convert carbon monoxide to carbon dioxide such that the energy released in the conversion is used to vaporize water, for example.

By use of the cleaning device 124, it may be guaranteed that the exhaust gas stream is cleaned before it is provided to the CO boiler 112, thereby enabling an achievement of lower contamination and, thus, a reduced maintenance requirement for the CO boiler 112.

The example of the FCC unit 100 described in FIG. 2 functions as follows: crude oil is provided to the cracking section 104 of the cracking device 102 via the crude oil feed line 106 and, thus, brought into contact with catalyst material. In this example process, the crude oil is converted to a large number of lighter petroleum fractions, which are discharged via the product discharge line 108, for example.

In this example, the catalyst material is contaminated with coke in conversion of the crude oil and must therefore be regenerated before reuse. According to the illustrated example, the regeneration takes place in the two regeneration stages 110a, 110b. In this example, the exhaust gas produced during regeneration of the catalyst material is provided via the waste heat boiler 114 and directly to the cleaning device 124.

By use of the feeding device 126 of the example cleaning device 124, an ammonia-containing additive (e.g., an ammonia-air mixture) is provided to the exhaust gas stream. Further, by use of the feeding device 126, an additive containing calcium carbonate such as, in particular, aqueous lime solution is provided into the exhaust gas stream.

By use of the mixing device 132, the exhaust gas stream is mixed with the provided additives so that, in particular, the sulfur oxide may react with the lime-containing additive to form gypsum, for example. In such examples, the ammonia-containing additive and nitrogen present in the exhaust gas stream react together in the catalyst separating device 130 to form nitrogen and further products to reduce and/or remove the nitrogen oxide from the exhaust gas stream.

In the catalyst separating device 130, solid particles present in the exhaust gas stream are separated, so that the exhaust gas stream leaving the cleaning device 124 finally contains the smallest possible amount of nitrogen oxides, sulfur oxides, and solid particles.

Further, by use of a measuring device and/or a control device of the cleaning device 124, control and/or regulation of the feeding device 126 may be carried out such that providing the ammonia-containing and/or lime-containing additive can be controlled and/or regulated depending on a measured nitrogen oxide content or sulfur oxide content of the exhaust gas stream leaving the cleaning device 124, for example.

In some examples, after the catalyst separating device 130 operates for a particular and/or defined period of time, a filter cake of increasing size forms on the catalyst separating device 130, which may impair the operation thereof. Regular cleaning of the catalyst separating device 130 can, therefore, be carried out in order to ensure reliable operation of the cleaning device 124. For this purpose, backflushing may be carried out by the backflushing device 134, in which the stream flows through the catalyst separating device 130 in a flow direction opposite to the flow direction during the separation operation of the catalyst separating device 130, for example. In this manner, the filter cake removed by the catalyst separating device 130 may be blown out of the catalyst separating device 130.

By use of the discharge device 136, this filter cake can be discharged and fed to a disposal unit. In this example, the exhaust gas stream exiting the cleaning device 124 is, thus, provided as a cleaned exhaust gas stream to the CO boiler 112 to utilize the energy remaining therein in the form of carbon monoxide for water vapor production. The exhaust gas stream is then released into the environment via the exhaust air discharge line 122, for example.

In other respects, the second example of the FCC system 100 shown in FIG. 2 corresponds in structure and function to the first example shown in FIG. 1, and reference is therefore made to the above description thereof.

In a third example of an FCC unit 100, the schematic view of which corresponds to the example shown in in FIG. 2, it may be provided that the example conversion device 140 to convert carbon monoxide to carbon dioxide while utilizing the energy released in the conversion includes a gas turbine unit 142, which may be implemented, in particular, as a micro gas turbine unit 142, or is integral with a gas turbine unit 142 (e.g., a micro gas turbine unit 142).

By using a cleaning device 124 that, in particular, is positioned in an inlet of the gas turbine unit 142, that is implemented as, in particular, a micro gas turbine unit 142, the gas turbine unit 142 (e.g., the micro gas turbine unit 142) may be protected from undesired or undesirably concentrated impurities.

In this example, the gas turbine unit 142 (e.g., a micro gas turbine unit 142) may be thermally coupled to additional components of the FCC unit 100 such as, for example, the waste heat boiler 114. Heat produced by the gas turbine unit 142 (e.g., a micro gas turbine unit 142) can, thus, contribute toward more efficient operation of the FCC unit 100, for example.

Moreover, a thermal energy source and/or electrical energy may be provided by the example conversion device 140 configured as a gas turbine unit 142 (e.g., a micro gas turbine unit 142), but also by a conversion device 140 configured as a CO boiler 112, for example. For example, a thermal energy source may be a warmed, heated, and/or vaporized fluid such as water, and/or a hot gas, in particular hot exhaust gas.

In some examples, it can further be provided that the thermal energy of the exhaust gas stream from the CO boiler 112 is used to produce electrical energy, for example, by an organic Rankine cycle unit (ORC unit).

In other respects, the third example of an FCC unit 100 also shown in FIG. 2 corresponds in structure and function to the second example, and reference is therefore made to the above description thereof.

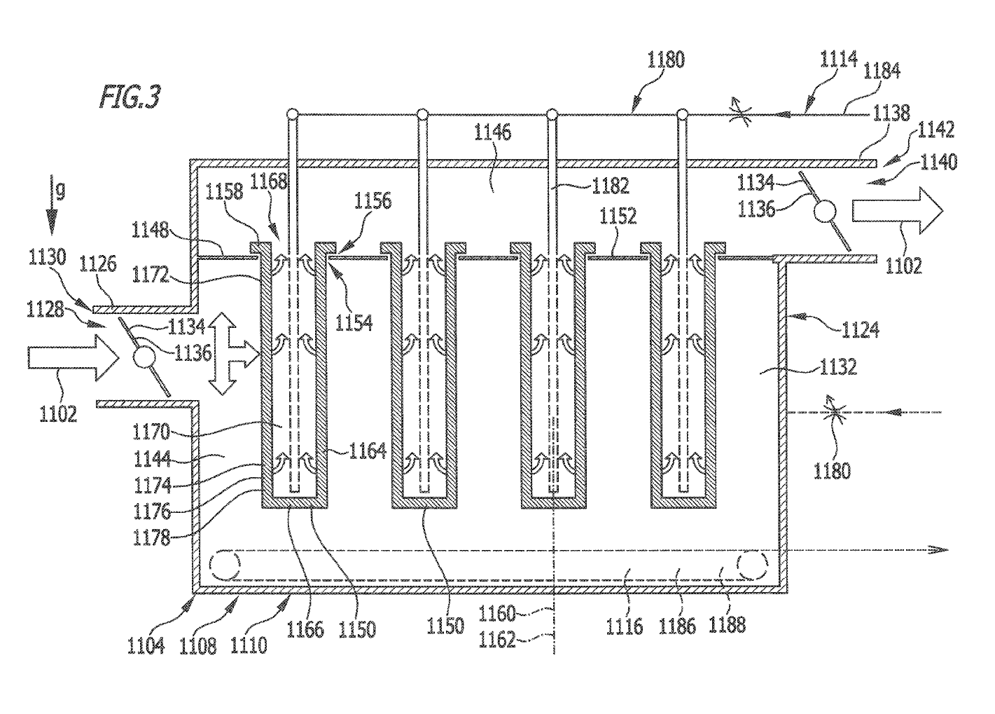

FIG. 3 shows an example of a separating device 1108 that is, preferably, used as a separating device 128 of the cleaning device 124 shown in FIG. 2. The separating device 1108 of the illustrated example is configured as a catalyst separating device 1110 and is used for filtration separation of particles, in particular solids, and also for the catalytic conversion of harmful gases.

The example separating device 1108 includes a separating chamber 1124. The separating chamber 1124 includes a feed section 1126, which preferably includes an inlet opening 1128 and/or an inlet connector 1130. In this example, the exhaust gas stream 1102 to be cleaned is provided into an internal compartment 1132 of the separating chamber 1124 via the feed section 1126.

According to the illustrated example, a valve device 1134 or flap device 1136 positioned in the feed section 1126 is, preferably, used to control and/or regulate the volume flow of the provided exhaust gas stream 1102. The separating chamber 1124 further includes a discharge section 1138, which preferably includes an outlet opening 1140 and/or an outlet connector 1142, for example.

In this example, the exhaust gas cleaned in the separating chamber 1124 can be discharged via the discharge section 1138. To control and/or regulate the volume flow of the discharged exhaust gas stream, a valve device 1134 and/or a flap device 1136 is, preferably, provided in the discharge section 1138, for example.

The example internal compartment 1132 of the separating chamber 1124 is divided into a raw gas compartment 1144 and a clean gas compartment 1146. In this example, the raw gas compartment 1144 and the clean gas compartment 1146 are separated from one another by a mounting device 1148 and a plurality of separating elements 1150 of the separating device 1108.

In this example, the mounting device 1148 contains the plurality of separating elements 1150. The mounting device 1148 is, in particular, configured as a separating wall 1152 of the internal compartment 1132 of the separating chamber 1124. The separating wall 1152 includes a plurality of duct openings 1154 which form holders 1156 for the separating elements 1150. In this example, the separating elements 1150 are, in particular, detachably couplable or fixed in the duct openings 1154.

In a fixed (mounted) state of the separating elements 1150, said elements are positioned for example with a collar 1158 of the respective separating elements 1150 sealed against the separating wall 1152 in order to prevent unwanted penetration (leakage) of the exhaust gas to be cleaned from the raw gas compartment 1144 into the clean gas compartment 1146.

As can be seen from the enlarged view of separating elements 1150 shown in FIG. 4, an example separating element 1150 is shaped as a generally hollow cylindrical body. In particular, the separating element 1150 may be a generally hollow circular cylindrical body. Alternatively, other elongated hollow bodies may also be implemented as a separating element 1150. Examples of suitable elements are generalized hollow cylinders with polygonal cross-sectional surfaces (such as triangular, square, pentagonal, hexagonal, or octagonal cross-sections or higher-order polygons and/or five, six, or multiple-pointed star-shaped cross-sections) and/or cross-sectional surfaces with parabolic, elliptical, or hyperbolic sections. In this example, higher-order cross-sectional geometries (such as star surfaces) may be advantageous in that they provide larger sheath surfaces on the separating element 1150.

The example separating element 1150 is, preferably, configured to be rotationally symmetrical around a longitudinal axis 1160 of the separating element 1150. The example longitudinal axis 1160 is, therefore, a symmetrical axis 1162 of the separating element 1150. In some examples, a separating element 1150, preferably, includes a hollow cylindrical section 1164, which along with the longitudinal axis 1160 is also adjacent at one end to a closed end 1166 of the separating element 1150 and, at the other end, to an open end 1168 of the separating element 1150.

In some examples, the open end 1168, in particular, is provided with the collar 1158 to fasten or couple the separating element 1150 to the mounting device 1148. In this example, with the closed end 1166, the separating element 1150, when mounted on the mounting device 1148, extends into the raw gas compartment 1144 of the separating chamber 1124 so that the closed end 1166, as well as essentially the entire hollow cylindrical section 1164 are enclosed in and/or surrounded by raw gas during operation of the separating device 1108.

In this example, an internal compartment 1170 of the separating element 1150 is configured by the open end 1168 in such a way that it opens into the clean gas compartment 1146. The separating element 1150, in particular, the hollow cylindrical section 1164, may preferably be configured to be gas-permeable, such that pores provided for this purpose have a small enough diameter that while gaseous substances can pass through the hollow cylindrical section 1154 of the separating element 1150, solids and fluids accumulate on an outer side 1172 of the separating element 1150, for example.

Thus, the example separating element 1150 is implemented, in particular, as a surface filter 1174. In some examples, the separating element 1150 can, therefore, also be designated filter element 1176. In particular, in examples where the separating element 1150 is composed of a ceramic and/or metallic material, the element is, preferably configured, as a filter candle 1178.

The separating device 1108 further preferably includes a cleaning device 1180, which may consist of a backflushing device 1114 in some examples. The cleaning device 1180 of the illustrated example includes, in particular, one or a plurality of backflushing lances 1182, by which a gas pressure pulse (e.g., a compressed air pulse) can be emitted from a clean gas side of each separating element 1150 facing the clean gas compartment 1146 onto the respective separating element 1150.

By use of the backflushing device 1114 in this example, a gas stream can, thus, be produced in a direction opposite to the flow direction of the exhaust gas stream 1102 during removal by the separating device 1108. In this manner, particles adhering to the outer side 1172 of a separating element 1150 are detached from the outer side 1172. The separating element 1150 is, therefore, cleaned.

Particularly, in examples where the backflushing device 1114 provides backflushing with compressed air, the cleaning device 1180 may also be designated as compressed air device 1184.

Alternatively or additionally to the above-described example cleaning device 1180 configured as a compressed air device 1184, a cleaning device 1180 may be provided by which a fluid such as a cleaning fluid or a cleaning gas can be provided into the raw gas compartment 1144 of the separating chamber 1124 to substantially remove impurities adhering to the outer side 1172 of the separating elements 1150, for example.

In some examples, deposits removed from the separating elements 1150 fall in the direction of gravity, g, onto a discharge device 1116 of the separating device 1108. The example discharge device 1116 is configured as a transportation belt 1186 or conveyor belt 1188 and allows simple conveyance of separated impurities from the internal compartment 1132 of the separating chamber 1124.

According to the above, a separating element 1150 in the singular was referred to in some examples, and a plurality of separating elements 1150 in the plural was referred to in other examples. It should be noted in this respect that the described features of one separating element 1150 may be implemented in all separating elements 1150. A separating device 1108 then may, preferably, includes a plurality of essentially identically and/or similar configured separating elements 1150. However, it can also be provided that a separating device 1108 includes differently configured separating elements 1150, in which features different from those mentioned herein are implemented.

The example of a separating device 1108 shown in FIG. 3 functions as follows: By the feed section 1126, an exhaust gas stream to be cleaned 1102 is provided via an exhaust gas emitting unit 1100, in particular, the example FCC unit 100 into the internal compartment 1132 of the separating chamber 1124. In some examples, the impurities contained in the exhaust gas stream 1102, in particular, solids and harmful gases, are then transported by suction or pressure in the direction of the separating element 1150.

In some examples, the solids accumulate on the outer sides 1172 of the separating elements 1150, as these are too large to allow passage through the separating elements 1150, for example.

The harmful gases, on the other hand, flow through the separating elements 1150, and in this process, however, are brought into contact with a catalytically active material to be described below and, preferably, converted to less harmful substances in some examples. In this example, the exhaust stream flows through the separating elements 1150 generally along a radial direction 1194 with respect to the symmetrical axis 1162 from the outside to the inside. In this example, cleaned exhaust gas from which solids and harmful gases, in particular, have been removed may collect in the interior spaces 1170 of the separating elements 1150.

By the open end 1168 of each separating element 1150, the cleaned exhaust gas is provided from the internal compartment 1170 of the respective separating element 1150 into the clean gas compartment 1146 of the separating chamber 1124, for example. By the example discharge section 1138, the cleaned exhaust gas is discharged from the internal compartment 1132 of the separating chamber 1124. By the example valve devices 1134 and/or the flap devices 1136, the flow of the exhaust gas stream 1102 through the separating chamber 1124 can be regulated.

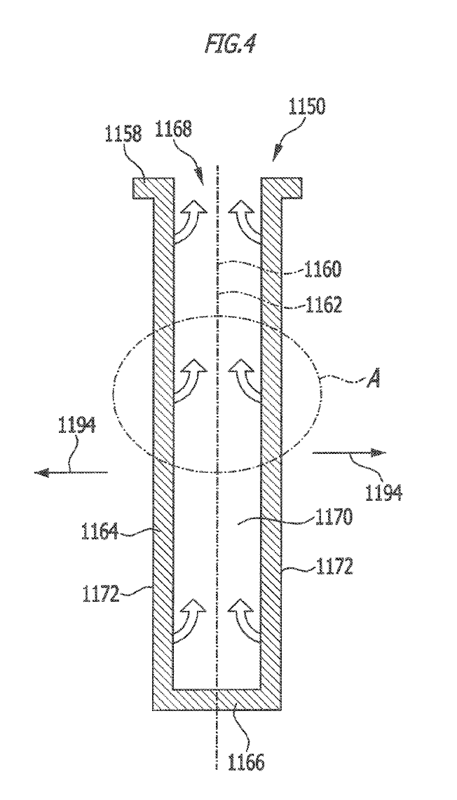

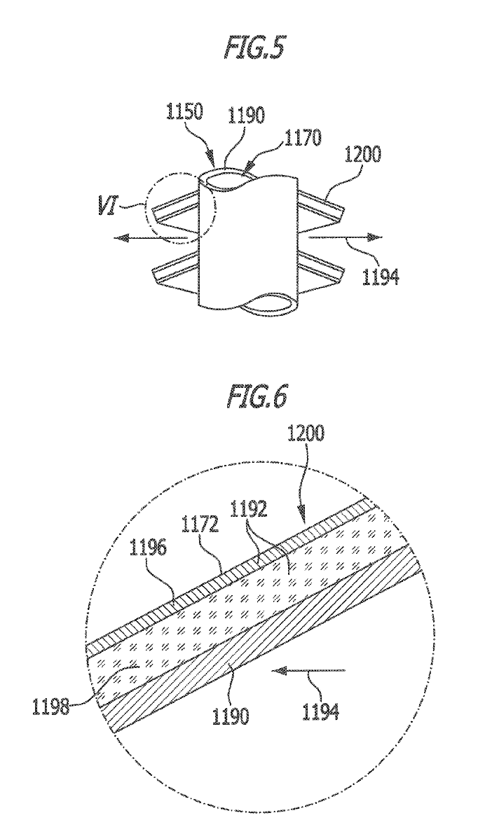

FIGS. 5 through 12 show various examples of separating elements 1150 that can be used as separating elements 1150 in the separating device 1108 shown in FIG. 3. Moreover, further separating elements 1150 may also be used in the separating device 1108, which other combinations for example have individual or multiple features of the examples shown in FIGS. 5 through 12.

In the first example of the separating element 1150 shown in FIGS. 5 and 6, it is provided that the separating element 1150 include a base element 1190 having two coatings 1192. In this example, the coatings 1192 are arranged on the base element 1190 on the outer side of the base element generally in a radial direction 1194 with respect to the longitudinal axis 1160.

In some examples, one of the coatings 1192 is configured as a protective layer 1196, which can optionally be provided on the separating element 1150. In some examples, the other coating 1192 is configured as a catalytically active coating 1198. In this example, the protective layer 1196 is arranged on the catalytically active coating 1198 that, in turn, is arranged on the base element 1190. In some examples, the base element 1190 is, in particular, a porous carrier, which may be composed of an aluminum foam or a sintered metal.

The example catalytically active coating 1198 may include, for example, a material containing copper, nickel, nickel oxide, palladium, platinum, rhodium, gold and/or any other appropriate catalytically active elements and/or compounds. In some examples, the catalytically active coating 1198 is, preferably, chemically and/or physically bonded to the base element 1190. In some examples, the protective layer 1196 is at least partially composed of a polytetrafluoroethylene material (PTFE), polypropylene (PP), polyethylene (PE), and/or polyamide (PA) or a combination of the aforementioned materials. In some examples, The protective layer 1196 is configured, in particular, as a perforated or otherwise gas-permeable film, a mesh, or a coating or vapor-deposition coating on the catalytically active coating 1198.

In some examples, both the base element 1190 and the catalytically active coating 1198 and protective layer 1196 are, preferably, permeable only to gases, so that solids are removed as a filter cake on the outer side 1172 of the separating element 1150 formed by the protective layer 1196. As can be seen in the example of FIG. 5 in particular, the separating element 1150 has a structured surface. In particular, a zigzag course of the surface of the separating element 1150 may be formed by projections 1200 extending outward in a radial direction 1194. This makes it possible to provide a separating element 1150 with a relatively large outer surface (outer side 1172).

The first example of a separating element 1150 shown in FIGS. 5 and 6 functions as follows: The exhaust gas to be cleaned is caused to flow into the separating element 1150 in a radial direction 1194 from the outside to the inside. In this example, solids and other fairly large particles of the exhaust gas stream 1102 then accumulate on the outer side 1172 of the separating element 1150, in particular, on the protective layer 1196, forming a filter cake.

In this example, gaseous components of the exhaust gas stream pass through the protective layer 1196, the catalytically active coating 1198, and the base element 1190 into the internal compartment 1170 of the separating element 1150. If applicable, potentially harmful gases, for example, nitrogen oxide or non-volatile organic hydrocarbons (volatile organic compounds; VOC), are chemically converted with the help of an additive by the catalytically active coating 1198. In some examples, exhaust gas that has been cleaned of solids and other particles, as well as harmful gases, preferably, collects in the internal compartment 1170 of each separating element 1150.

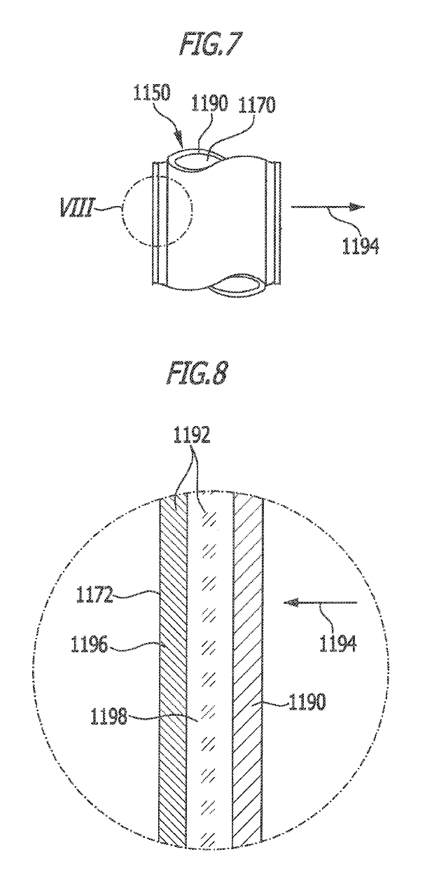

A second example of a separating element 1150 shown in FIGS. 7 and 8 differs from the first example shown in FIGS. 5 and 6 essentially in that the base element 1190, the catalytically active coating 1198, and the protective layer 1196 are configured in a generally hollow cylindrical form and have little or no projections 1200. In particular, such a separating element 1150 may be simply and economically produced.

In other respects, the second example of a separating element 1150 shown in FIGS. 7 and 8 corresponds in structure and function to the first example shown in FIGS. 5 and 6, and reference is therefore made to the above description thereof.

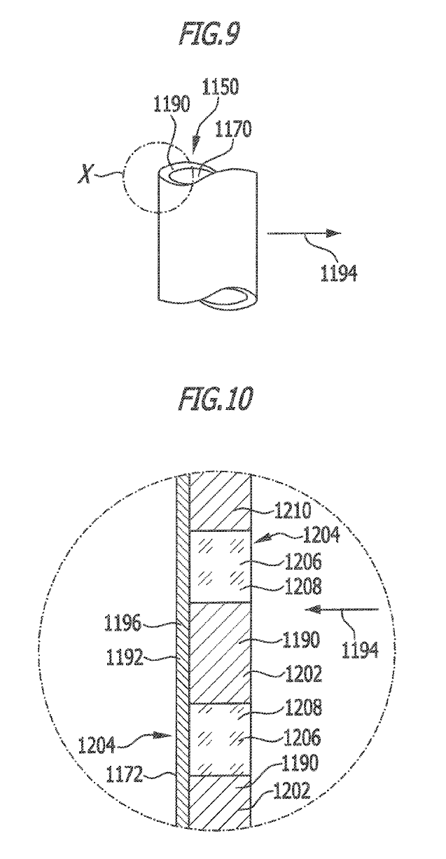

A third example of a separating element 1150 shown in FIGS. 9 and 10 differs from the second example shown in FIGS. 7 and 8 essentially in that the base element 1190 is configured as a grid 1202. The base element 1190, thus, includes a large number of penetration openings 1204 configured in the form of a matrix.

In this example, the penetration openings 1204 are filled with a filling 1206. In particular, the filling 1206 is a catalytically active filling 1208.

In this example, the base element 1190 provided with the catalytically active filling 1208 forms and/or defines a permeable wall 1210, in which a gas-impermeable or gas-permeable grid section of the grid 1202 and the catalytically active filling 1208, which may be gas-permeable, alternatively.

Moreover, the separating element 1150 according to the third example shown in FIGS. 9 and 10 comprises a coating 1192 configured as a protective layer 1196 that forms the outer side 1172 of the separating element 1150 and is, thus, arranged outside in a radial direction 1194 on the grid 1202 provided with the catalytic filling 1208.

The third example of the separating element 1150 shown in FIGS. 9 and 10 may be produced, for example, by providing the grid 1202 with the catalytically active filling 1208. The coating 1192 is preferably applied thereafter. In some examples, these steps can preferably be carried out in one plane (e.g., essentially two-dimensionally).

In some examples, to produce the cylindrical separating elements 1150, in particular, the hollow cylindrical sections 1164, the base element 1190 is preferably rolled up together with the filling 1208 and the protective layer 1196. This rolling up may result in a single-layer or a multilayer configuration of the separating element 1150, for example.

In other respects, the third example of a separating element 1150 shown in FIGS. 9 and 10 corresponds in structure and function to the second example shown in FIGS. 7 and 8, and reference is therefore made to the above description thereof.

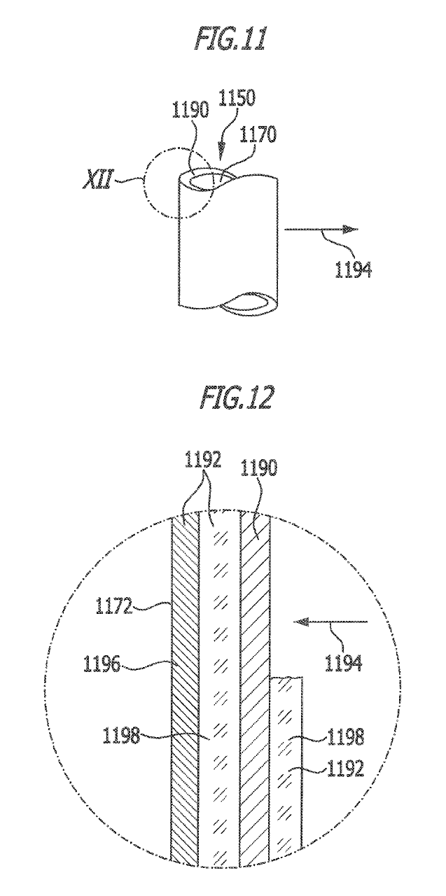

A fourth example of a separating element 1150 shown in FIGS. 11 and 12 differs from the second example shown in FIGS. 7 and 8 essentially in that the base element 1190 is partially or completely provided on an outer side in a radial direction 1194 with a catalytically active coating 1198.

Alternatively or additionally, it may be provided that the base element 1190 is partially or completely provided on an inner side in a radial direction 1194 with a catalytically active coating 1198. Here, the material of the base element 1190 is for example a foam, a woven fabric, a knit fabric, and/or a fiber composite.

In the fourth example of the separating element 1150 shown in FIGS. 11 and 12, an outer side 1172 of the separating element 1150 is formed by a protective layer 1196. In other respects, the fourth example of a separating element 1150 shown in FIGS. 11 and 12 corresponds in structure and function to the second example shown in FIGS. 7 and 8, and reference is therefore made to the above description thereof.

This patent arises as a continuation-in-part of International Patent Application No. PCT/EP2015/068648, which was filed on Aug. 13, 2015, and which claims priority to German Patent Application No. 10 2014 112 425.1, which was filed on Aug. 29, 2014. The foregoing International Patent Application and German Patent Application are hereby incorporated herein by reference in their entireties.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A treatment device to treat a carbon monoxide-containing exhaust stream, the treatment device comprising:
a conversion device to convert carbon monoxide to carbon dioxide, wherein energy released in the conversion is to be used to provide at least one of thermal energy or electrical energy; and
a cleaning device to substantially clear the exhaust gas stream to be provided to the conversion device, wherein the cleaning device is provided upstream and in an inlet of the conversion device.

2. The treatment device defined in claim 1, wherein the cleaning device (124) includes a feeding device to provide at least one additive to the exhaust gas stream, by which an ammonia-containing and/or lime-containing additive can be provided to the exhaust gas stream.

3. The treatment device as defined in claim 1, wherein the cleaning device includes a separating device.

4. The treatment device as defined in claim 3, wherein the separating device is a catalyst separating device.

5. The treatment device as defined in claim 3, wherein the cleaning device includes a backflushing to clean the separating device.

6. The treatment device as defined in claim 1, wherein the cleaning device includes a discharge device, by which solids separated from the exhaust gas stream can be discharged.

7. The treatment device as defined in claim 1, wherein the conversion device includes at least one gas turbine unit (142) or is composed thereof, which is thermally coupled to further components of the FCC unit.

8. A method to treat a carbon monoxide-containing exhaust stream, the method comprising:
cleaning an exhaust gas stream of via a cleaning device, wherein the exhaust gas stream is provided to the cleaning device and cleaned by at least one of separation of particles or catalytic conversion of at least one harmful substance;
providing the cleaned exhaust gas stream to a conversion device; and
converting carbon monoxide to carbon dioxide by the conversion device, wherein the energy released in the conversion is used to supply at least one of thermal energy or electrical energy.

9. The method defined in claim 8, wherein at least one additive is provided to the exhaust gas stream by a feeding device (126).

10. The method as defined in claim 9, wherein by the feeding device, an ammonia-containing and/or a lime-containing additive is provided to the exhaust gas stream.

11. The method as defined in one of claims 8 through 10, characterized in that by a separating device (128) of the cleaning device, solids are separated from the exhaust gas stream.

12. The method as defined in claim 11, wherein the stream is to flow through the separating device to substantially remove separated solids by a backflushing device of the cleaning device in a direction opposite to the flow direction of the separating device during a separation operation.

13. The method as defined in claim 11, wherein the solids separated in the separating device are to be discharged from the separating device by a discharge device of the cleaning device.

14. Use of a treatment device as defined in claim 1 to treat a carbon monoxide-containing exhaust stream, in particular for carrying out a method as defined in claim 8.

15. The use as defined in claim 14, wherein the cleaning device is arranged upstream of the conversion device.

16. The treatment device as defined in claim 1, wherein the energy released is utilized for at least one of a CO boiler, a gas turbine unit, or a micro gas turbine unit.

17. The treatment device as defined in claim 2, wherein the feeding device further includes a mixing device, by which one or a plurality of additives and/or the exhaust gas of the exhaust gas stream are miscible with one another.

18. The method as defined in claim 11, wherein the thermal energy is used to vaporize water.

19. The method as defined in claim 11, wherein the separating device includes a filter device.

20. The method as defined in claim 19, wherein the filter device includes a catalyst separating device.
